(19) United States
(12) Patent Application Publication
(10) Pub. No.: US 2003/0033740 A1
(43) Pub. Date: Feb. 20, 2003

(54) Method of warning of a hazard until the hazard is removed using a mat having cautionary information

(75) Inventor: Thomas Perelli, Winchester, VA (US)

Correspondence Address: Andrew E. Rawlins, Foley & Lardner, Suite 500, 3000 K Street, NW, Washington, DC, 20007-5109, US

(73) Assignee: RUBBERMAID COMMERCIAL PRODUCTS LLC.

(21) Appl. No.: 09/931,074

(22) Filed: Aug. 17, 2001

(51) Int. Cl. G09F 7/00; G01D 11/00; G01D 13/00; G08B 1/00; G09B 1/00; A47B 41/00

(52) U.S. Cl. 40/584; 116/201; 434/433

(57) ABSTRACT

A method of warning of a hazard includes placing a container containing a plurality of mats, having cautionary information thereon, in an area prone to hazards. In addition, the method contemplates that a first person who notices a hazard will remove a mat from the container and place it over the hazard to warn a subsequent passerby of the existence of the hazard. Finally, the method provides leaving the mat over the hazard until a second person removes the hazard. In addition, the method may include providing on the mats a liquid impermeable cover and a padded portion. The padded portion may aid the second person in eliminating a hazard involving sharp objects. Further, the padded portion may be absorbent to aid in eliminating a liquid hazard. Moreover, the mat or the cover may be brightly colored to attract the eye of passersby to aid in warning them of the hazard.

### BACKGROUND OF THE INVENTION

1. Field of the Invention

This invention relates to a method of warning of a hazard at least until the hazard is removed and, more particularly, to the use of a mat to warn of the hazard.

2. Description of the Related Art

Many public areas which experience heavy pedestrian traffic are highly prone to hazards, such as spilled foodstuffs. Examples of such areas include grocery stores, hospitals, amusement parks, movie theaters, shopping malls, cafeterias, restaurants, shopping centers, stables, and stadiums. Many people notice a hazard and take the necessary steps to avoid it. Other people, however, are not as fortunate. In particular, slip-and-fall injuries are frequent in supermarkets where foodstuffs may be on the floor or where broken jars and the contents they once contained may be strewn in an aisle.

Often a hazard will remain untouched until an employee removes it. For this to happen, however, an employee must first become aware of the hazard. Often an employee will not become aware of a hazard for a considerable amount of time. In the interim, someone may accidentally contact the hazard and become injured or spread the contents of the hazard. Spreading the hazard increases the likelihood that a subsequent passerby will contact the hazard.

Unnoticed hazards are frequently worsened in the shopping context during which pedestrians are frequently looking at products displayed to their side rather than looking at the flooring in front of them. For example, someone accidentally walking through a puddle of milk may splash it thereby increasing its area. Another concern is that someone may push a shopping cart through a puddle thereby wetting the wheels; the wheels then create paths of narrow wetness which are difficult to see and which extend until the wheels become dry again. As these paths of wetness are difficult to see, they present a great danger to a subsequent passerby.

Hazards unknown to an owner of an establishment open to the public also present grave perception problems. For example, whether a customer will choose to shop in a store may in large part depend on that customer's perception of the shopping environment. If spills and other hazards are present without sufficient warning, the customer may believe that the store has no commitment to cleanliness and that shopping therein may be risky.

To address these problems and concerns, people have tried putting a sign near a hazard to warn passersby of a hazard's existence. This method has proven inadequate. First, warning signs typically have not been stored in areas which are both prone to hazards and accessible to the general public. Rather, the signs have been maintained in locations inaccessible to the public, such as in supply rooms. Second, rather than preventing access to a hazard, signs have been designed to be placed adjacent or over a hazard in such a way that fails to eliminate the potential for a passerby to accidentally contact the hazard. Examples of such signs include standing foldable signs that say “Caution Wet Floor.” These signs may be placed over a puddle but do not completely cover the puddle. Third, if accidentally bumped, the signs may slide away from a hazard; a passerby later approaching the moved sign, may, in trying to avoid the sign, actually contact the hazard. Similarly, often these signs are placed adjacent to the hazard because the individual positioning the sign does not want to get the hazard on the sign. For example, if the hazard is spilled spaghetti sauce, an employee may not want to put the sign directly onto the sauce because the employee knows he will not only have to clean-up the spilled sauce but will also have to clean the sign. Fourth, most existing caution signs are made of non-absorbent materials and, therefore, fail to aid in eliminating a liquid hazard. Fifth, if the signs are made of a solid material such as hard plastic, they fail to aid in picking-up small, solid hazards such as broken glass.

### SUMMARY OF THE INVENTION

The present invention relates to a method of warning of a hazard at least until the hazard is removed. The method contemplates (a) storing a plurality of mats in a container located in an area prone to spills, the mats being configured to warn of a hazard; (b) having a passerby who notices a hazard remove a mat from the container and place the mat on the hazard to provide warning of the hazard; and (c) leaving the mat on the hazard until a second person removes the hazard.

In one embodiment, the method may further include ensuring that the mat is absorbent so that when placed over a liquid hazard, the mat will absorb some or all of the liquid hazard thereby aiding the second person in eliminating the hazard. Similarly, the method may include ensuring that the mat has a padded portion which is of a thickness which will aid the second person in picking-up a solid hazard such as broken glass without that individual injuring himself. In an even more preferred embodiment, a padded portion of the mat would also be absorbent.

As previously mentioned, the mats are provided in a container. In one embodiment of the method, the container may contain a plurality of mats stacked either individually or accordion style. Many other containers are also possible. For example, in another embodiment, the mats be provided on a roll whereon the mats are connected along lines of weakness.

The mats used in the method are configured to warn of a hazard. One embodiment of the mat includes providing cautionary information thereon. The cautionary information can be, for example, language, symbols, colors, or a combination of the three.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention. Together with the description, the drawings serve to explain the principles of the invention.

FIG. 1A is a perspective view of a caution mat according to a first embodiment of the present invention; FIG. 1B is a perspective view of a caution mat according to a second embodiment of the present invention which provides a cover on the mat;

FIG. 2 is a perspective view of a container containing a roll of the mats shown in FIG. 1, wherein the mats are connected along lines of weakness;

FIG. 3 is a perspective view of a container containing a stack of the mats shown in FIG. 1, wherein the mats are provided individually in the container; and

FIG. 4 is a break-away perspective view of a mat shown in FIG. 1, covering a hazard.

### DETAILED DESCRIPTION OF THE PREFERRED EMBODIMENTS

Reference will now be made in detail to the presently preferred embodiments of the invention, examples of which are illustrated in the accompanying drawings. Where possible, the same reference numbers will be used to refer to the same or like parts.

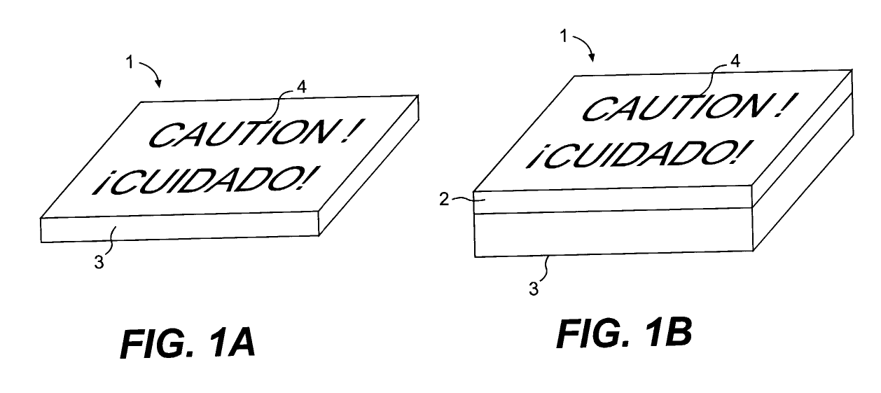

The invention described herein contemplates a method of warning of a hazard at least until the hazard is removed. With reference to FIGS. 1-4, the method includes providing, within an area prone to hazards 5, a container (more specifically, a dispenser) 6, 7 containing a plurality of mats 1; the mats 1 are configured to warn of a hazard 5. After a hazard 5 is created within that area, a first person removes a mat 1 from the container 6, 7 and places the removed mat 1 on the hazard 5 thereby providing a warning of the hazard 5 to, e.g., a subsequent passerby. The method also includes leaving the mat 1 on the hazard 5 until a second person removes the hazard 5. This method will be discussed in further detail, hereinafter.

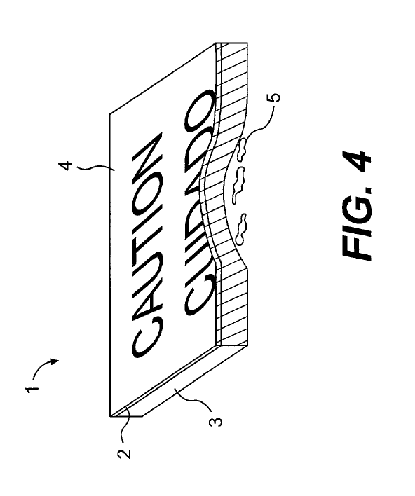

FIGS. 1A, 1B and 4 show a floor mat 1 which is configured to warn of a hazard 5. The mat 1 preferably contains a warning portion having cautionary information 4 thereon. The cautionary information 4 can be, for example, words (e.g., “caution,” “cuidado,” “actung,” “vorsicht,” etc.), symbols associated with a hazard (e.g., skull-and-crossbones, stop-sign, etc.), a color (e.g., bright yellow, bright red, or other eye-catching colors), or a combination of the three. The aforementioned examples for the cautionary information 4 are by no means limiting and all language, symbols, and colors that serve the purpose of warning of a hazard can be used.

In a first embodiment shown in FIG. 1A, the floor mat 1 can have cautionary information 4 provided (e.g., printed) directly on a padded portion 3. The padded portion 3 is preferably made of an absorbent material which will absorb and retain liquid or moisture onto which the mat 1 is laid. By way of example, the absorbent material could be blown polypropylene. Moreover, the padded portion 3 could be formed by a series of absorbent layers bonded together; there are a number of viable alternatives in which the bonding may occur, including thermal and ultrasonic bonds. In one preferred embodiment, the padded portion 3 is formed by a series of six to eight layers of blown polypropylene which are held together using thermal bonds. In addition, the liquid or moisture absorbed and retained by the padded portion 3 could be oils, coolants, acids, bases, solvents, water based liquids, and corrosives.

The thickness and the absorbency of the padded portion 3 may vary. For instance, if blown polypropylene is desired for the padded portion 3, it is commercially available in varying thicknesses. Preferably, the thickness of the padded portion 3 would be between 0.20 and 2.0 inches. More preferably, however, the mat will have a thickness of between 0.35 and 1.5 inches and most preferably between 0.5 and 1.0 inches. Accordingly, if the padded portion 3 comprises a stack of six blown polypropylene layers, each layer would have a thickness of between 0.03 and 0.33 inches; correspondingly, the more preferred layer thickness would be between 0.06 and 0.25 inches and the most preferred layer thickness would be 0.08 and 0.16 inches. In addition, preferably the mat 1 will absorb at least its weight in water, more preferably it will absorb at least twice its weight in water, even more preferably it will absorb at least four times its weight in water, even more preferably it will absorb at least 10.5 times its weight in water, and even more preferably it will absorb at least 12.5 times its weight in water.

In addition, the padded portion 3 may serve as a protective barrier to one who cleans-up the hazard 5. For example, if the hazard 5 is broken glass, the padded portion 3 can serve to insulate any exposed body parts (of the person cleaning-up the hazard 5) from the glass.

A second embodiment of the mat 1 may have a cover 2, as shown in FIG. 1B. In the embodiment of the mat shown in FIG. 1B, the cover 2 may display the cautionary information 4. The mat 1 may also have a padded portion 3 (like the embodiment shown in FIG. 1A) positioned directly below the cover 2. Although the cover may be made from a variety of materials, if blown polypropylene is chosen for the padded portion 3, it is preferable to use spun-bond polypropylene for the cover 2. In addition, the cover 2 is preferably impermeable to liquids. By being impermeable to liquids, one cleaning-up a spill can avoid direct contact with it. Moreover, the impermeability will keep the top surface of the cover 2 dry thereby reducing the likelihood of a slip-and-fall by one who fails to see the mat 1 and accidentally steps on it.

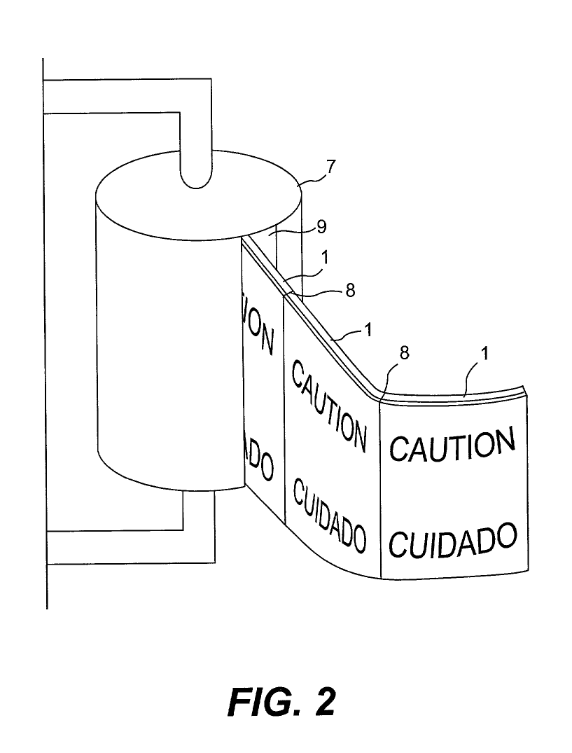

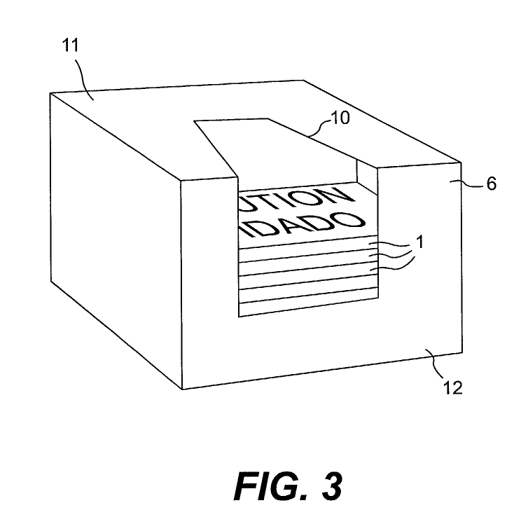

Turning to FIGS. 2 and 3, in performing the method, a container 6, 7 containing a plurality of mats 1 is placed in an area prone to spills. As previously mentioned, an area of this nature would include, but is not limited to, a grocery store, a hospital, an amusement park, a movie theater, a shopping mall, a cafeteria, a restaurant, a shopping center, a stable, and a stadium. Preferably the container 6,7 is placed in an area where patrons have ready access to the container 6,7. For example, in a grocery store the container 6,7 could be placed in an aisle of a grocery store, a hallway of a hospital, a walkway of an amusement park, a lobby of a movie theater, a common area of a shopping mall, or a dining area of a cafeteria or a restaurant.

FIG. 2 shows a first embodiment of a container, namely a cylinder 7 having an opening 9 therein. The cylinder 7 contains a plurality of mats 1, connected along lines of weakness 8, which are rolled together and which project out of the cylinder 7 through the opening 9. Ideally, the lines of weakness 8 are perforations thereby allowing one who notices a hazard to tear-off easily as many mats 1 as are needed while leaving the remainder of the plurality housed within the cylinder 7.

As shown in FIG. 3, a second embodiment of the container is a box container 6. The box container 6 contains a stack of mats 1 and has an opening 10 therein which is formed partially in the top side 11 and partially in the front side 12 thereof. However, the invention is not so limited. For example, the box container 6 could be designed similar to a tissue box whereby a mat 1 partially sticks through an opening in the top side of the box and can be pulled out of the box while pulling a second mat 1 upward so that the second mat 1 partially sticks through the opening after the first mat 1 is removed. In addition, although it is preferable for the mats 1 to be separately stacked in the box container 6 (so that one mat can be removed very easily), it is also possible to stack a plurality of mats 1, connected by lines of weakness 8, accordion style in the box container 6. In this fashion, one who intends to cover a hazard can easily pull a bunch of mats 1 out of the box container 6 and then separate the mats 1 which are needed from the remainder of the mats 1 by tearing along the line of weakness 8 between the last mat 1 which is needed and the next mat 1 which will remain in the box container 6.

In performing the method, a person who notices a hazard 5 (in an area prone to hazards) removes a mat 1 from a container 6, 7 and places it over the hazard 5. This person may be, for example, a customer in a grocery store. FIG. 4 shows a break-away perspective view of a mat 1 placed over a hazard 5. The hazard 5 can be a variety of problems including, but not limited to, liquid, moisture, broken glass, foodstuffs, loose flooring, animal feces, and missing flooring. The mat 1 is then left on the hazard 5 until a second person removes the hazard 5. The second person can be, for example, an employee of the grocery store.

Many obvious alterations can be made to the invention herein described. For example, the size, shape, and color can easily be changed. In addition, the cautionary information and content of the warning can be changed. Of course, the mat can also be used to address various other floor related hazards which were not discussed; these alterations and additional hazards are fully within the scope of this invention.

Although the aforementioned describes preferred embodiments of the invention, the invention is not so restricted. Other embodiments of the invention will be apparent to those skilled in the art from consideration of the specification and practice of the invention disclosed herein. It is intended that the specification be considered as exemplary only, with a true scope and spirit of the invention being indicated by the following claims.

What is claimed is:

1. A method of warning of a hazard at least until the hazard is removed, the method comprising the steps of:
providing, within an area prone to hazards, a container containing a plurality of mats, the mats being configured to warn of a hazard;
after a hazard is created within the area, a first person removing a mat from the container and placing the removed mat on the hazard so as to provide warning of the hazard;
leaving the mat on the hazard until a second person removes the hazard.

2. The method of claim 1, wherein the container is configured to permit removal of an individual mat from the plurality of mats in the container.

3. The method of claim 2, wherein the mats are provided on a roll in the container and adjacent mats on the roll are connected to each other along lines of weakness that ease separation of the adjacent mats.

4. The method of claim 3, wherein the lines of weakness are perforations.

5. The method of claim 2, wherein the mats are provided in a stack in the container.

6. The method of claim 1, wherein the mats are configured to warn of a hazard by displaying cautionary language.

7. The method of claim 1, wherein the mats are configured to warn of a hazard by displaying a color associated with hazard warnings.

8. The method of claim 1, wherein the mats are configured to warn of a hazard by displaying a cautionary symbol.

9. The method of claim 1, wherein the hazard is at least one of liquid, moisture, broken glass, loose flooring, foodstuffs, animal feces, and missing flooring.

10. The method of claim 1, wherein the area prone to hazards is selected from the group consisting of a grocery store, a hospital, a movie theater, an amusement park, a cafeteria, a restaurant, a stable, and a stadium.

11. The method of claim 1, wherein the mats have an absorbent portion.

12. The method of claim 11, further comprising the step of absorbing a fluid associated with the hazard with the absorbent portion of the mat placed on the hazard.

13. The method of claim 1, wherein the mats have a padded portion.

14. The method of claim 13, wherein the hazard is broken glass, said method further comprising the step of picking-up the broken glass with the padded portion.

15. The method of claim 11, wherein the absorbent portion is padded.

16. The method of claim 15, wherein the hazard is broken glass, said method further comprising the step of picking-up the broken glass with the padded absorbent portion.

17. The method of claim 1, wherein the mat has a cover portion and a padded portion.

18. The method of claim 17, wherein the cover portion is substantially impermeable to fluid whereas the padded portion is absorbent.
